(19) United States
(12) Patent Application Publication
(10) Pub. No.: US 2019/0075736 A1
(43) Pub. Date: Mar. 14, 2019

(54) SECURE GREENHOUSE

(71) Applicant: MICHAEL ROBERTS, CALGARY (CA)

(72) Inventor: MICHAEL ROBERTS, CALGARY (CA)

(21) Appl. No.: 15/704,260

(22) Filed: Sep. 14, 2017

(51) Int. Cl. A01G 9/24; A01G 9/14

(52) U.S. Cl. CPC A01G 9/241; A01G 9/1438

(57) ABSTRACT

A securable greenhouse is described. The greenhouse includes a frame upon which a first covering is placed to prevent access to the interior of the greenhouse. The first covering is a mesh constructed of expanded metal or similar materials. A second, transparent, covering separates the internal environment from outside, while a third, opaque, covering limits light entry into the greenhouse and visibility of the contents within, and which can be deployed or retracted as needed. A ventilation system controls air flow in, through and out of the greenhouse to regulate parameters like temperature and relative humidity. The greenhouse has moveable and lockable roof panels to provide access to authorized users, and a side access door as an alternate access. An optional automated control system determines optimal growth conditions and adjusts various features in order to achieve those conditions.

### FIELD OF THE INVENTION

This invention is in the field of greenhouse structures, in particular, greenhouse structures that prevent unauthorized access.

### BACKGROUND

Greenhouses providing controlled environments are well known and have been in use for some time. Generally speaking, these greenhouses provide shelter for growing plants, as well as means for regulating temperature and humidity within the interior of the greenhouse. The use of greenhouses has made it possible to grow plants when outside conditions are less than favorable, or even prohibitive.

One limitation in prior art greenhouses is that they are not designed for growth of plants where quality control, or the nature of the plant itself, demands greater security. Prior art greenhouses are generally constructed to have transparent panes of either window or plastic that serve to admit light, and control air flow through the greenhouse. However, in prior art greenhouses, unauthorized access is not prevented.

Thus, given these limitations, what is needed is a greenhouse that provides the necessary means for providing an optimal growth environment, and a secure environment where quality control or the nature of the plants is subject to stringent regulation regarding growth and handling of plant material.

### SUMMARY OF THE INVENTION

The present disclosure provides embodiments of a secure greenhouse that provides for optimal growing conditions, while preventing unauthorized access to the interior of the greenhouse to anyone but authorized users. The greenhouse comprises a frame, the spaces between which are covered by a material that impedes physical access to the interior of the greenhouse. The outside of the greenhouse is covered by a second material that is generally transparent and which functions to admit light and separate the interior environment of the greenhouse from the outside environment to control temperature and relative humidity, among other parameters. A third covering material inside the greenhouse is deployable and is used to regulate the amount of ambient light that enters the greenhouse, as well as to limit the ability of those outside the greenhouse to view the contents.

The roof of the greenhouse is designed to comprise moveable panels to allow a user to gain access to the interior. The greenhouse may also include a side access door for a similar purpose. Both the roof panels and side access door can be locked to prevent unauthorized access to the contents of the greenhouse.

The greenhouse can also include a ventilation system comprising air intake and exhaust vents that can be operated to regulate the flow of air into, through, and out of the greenhouse. The roof panel can also include a roof vent to assist in the same purpose.

The greenhouse can be adapted to include a variety of other features such as automated control systems to regulate temperature, humidity, illumination, and the like, or to provide alerts to a user when conditions inside the greenhouse deviate significantly from optimal conditions.

Thus, in the present disclosure there is provided a securable greenhouse providing a secure facility and controlled environment for growing plants, comprising: a base, the base comprising a structure having a length and a width configured to provide a means of securing the greenhouse to a location; a frame, the frame connected to the base and comprising a plurality of frame members that define a structure having a length, a width and a height, thus forming a bounded interior region adapted to receiving plants, the bounded structure comprising sides and a roof; a first covering material, the first covering material configured to extend over the spaces formed by the plurality of frame members, wherein the first covering material is effective to substantially limit unauthorized access into the greenhouse; a second covering material, the second covering material overlying the first covering material, and effective to substantially limit the flow of air in and out of the interior of the greenhouse; wherein the first and second covering materials cooperatively form a plurality of sides, and a roof for the greenhouse, and wherein the roof further comprises at least one moveable roof panel, the at least one moveable roof panel configured to be movable between a closed position and an open position; a ventilation system, the ventilation system configured to provide controlled air exchange between the outside of the greenhouse and the interior of the greenhouse; at least one securable access, the at least one securable access configured to prevent unauthorized access to the interior of the greenhouse.

In some embodiments, the greenhouse further comprises a third covering material, the third covering material configured to be deployable to regulate the amount of light that enters the greenhouse from outside, and to protect the contents of the greenhouse from being viewed from outside the greenhouse.

In some embodiments, the securable access comprises at least one of a side access door and the moveable roof panel. In some embodiments, the moveable roof panel is configured to be moved between an open configuration and a closed configuration. In some embodiments, the moveable roof panel further comprises a lock, to prevent unauthorized access to the interior of the greenhouse when the moveable roof panel is in the closed configuration.

In some embodiments, the ventilation system comprises at least one air intake vent and at least one air exhaust vent, and wherein each of the at least one air intake vent and the at least one air exhaust are moveable between a closed and an open configuration.

In some embodiments, the greenhouse further comprises an artificial lighting system located within the interior of the greenhouse, the artificial lighting configured to provide a light source for plants placed within the greenhouse.

In some embodiments, the greenhouse further comprises a control system, the control system configured to determine an optimal parameter set, a parameter set comprising an amount of illumination, water, nutrients and temperature to which plants within the greenhouse will be exposed within a pre-determined period of time, and wherein the control system is configured to adjust the operation of the ventilation system, artificial lighting system, water and nutrient system, and deployment of the third covering in order to substantially achieve the optimal parameter set. In some embodiments, the control system is configured to be controlled a microprocessor. In some embodiments, the control system is configured to provide data to a user in order to manually control the amount of illumination, water, nutrients and temperature to which plants within the greenhouse will be exposed within a pre-determined period of time, in order to substantially achieve the optimal parameter set.

In some embodiments, the base further comprises a plurality of anchors configured to secure the greenhouse to one of the ground, a deck structure or a substantially solid pad structure.

In some embodiments, the first covering comprises a metal mesh, and the second covering comprises a substantially transparent material. In some embodiments, the third covering material is substantially opaque.

In some embodiments, the access door further comprises a locking mechanism accessible only from within the interior of the greenhouse.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1 depicts a perspective view of an embodiment of a greenhouse according to the present disclosure;

FIG. 2A depicts a view of one end of an embodiment of a greenhouse according to the present disclosure;

FIG. 2B depicts a view of an opposite end of an embodiment of a greenhouse according to the present disclosure;

FIG. 3A depicts an end view of an embodiment of a greenhouse according to the present disclosure, where the moveable roof panels are shown in an open configuration;

FIG. 3B depicts a perspective view of the embodiment of the greenhouse depicted in FIG. 3A;

FIG. 4A depicts a closer view of a corner of an embodiment of a greenhouse according to the present disclosure, showing the relationship between a roof panel and frame member, and an example of a means to secure a side access door;

FIG. 4B depicts an alternative embodiment of a locking structure for use with a greenhouse according to the present disclosure;

FIG. 5 depicts a top view of a base of an embodiment of a greenhouse according to the present disclosure, showing an example of locations on the base that can be used for anchoring the greenhouse to the ground or some other structure; and

FIGS. 6A and 6B depict embodiments of a greenhouse according to the present disclosure depicting the ability of the moveable roof panels to be in an open or closed position (FIG. 6A), and showing detail of the roof cap trim and a roof vent in the open position (FIG. 6B).

### DETAILED DESCRIPTION OF THE INVENTION

The following discussion provides examples of embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Those of skill in the art will recognize that the described embodiment are examples of possible configurations of the invention, and are not intended to be limiting to the scope of the invention. Accordingly, the drawings and descriptions contained herein are to be regarded as illustrative of the invention as set forth in the accompanying claims.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Greenhouses have been used for several years in order to provide a controlled environment for the growth of plants. With the increasing interest in growing various plants for the production of medicinal products, there is a need to provide a more secure environment for plants, as well as features to carefully regulate the growing conditions, including temperature, light exposure, and the provision of water and other nutrients in order to optimize growth conditions. The present disclosure describes securable greenhouse designed to provide a secure facility and controlled environment for growing plants.

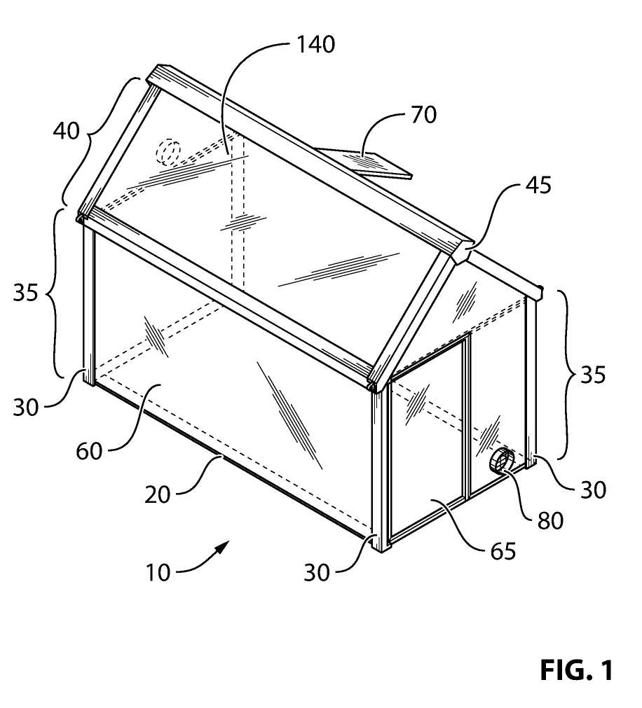

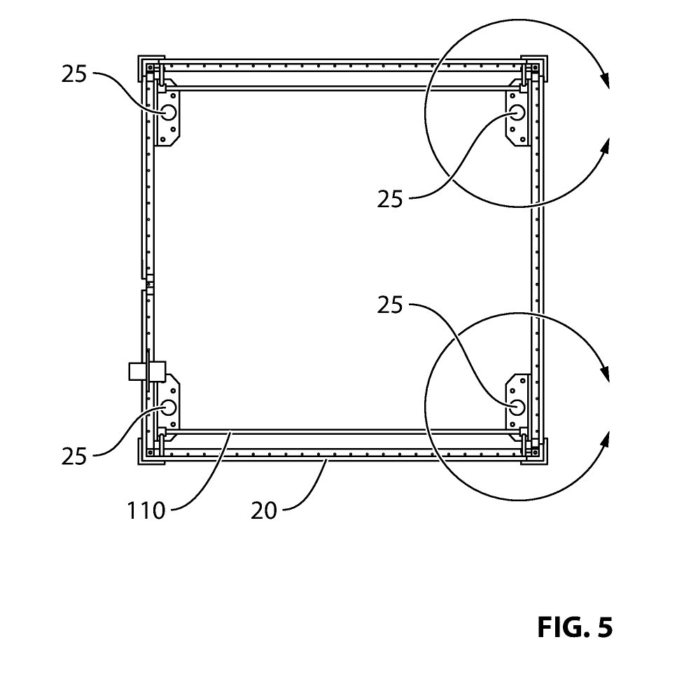

As shown in FIG. 1, a secure greenhouse 10 of the present disclosure comprises a base 20, the base comprising a structure having a length and a width configured to provide a means of securing the greenhouse to a location. The location where the greenhouse can be placed is quite adaptable, and includes securing directly to the ground, or to a structure such as a deck, or a pad, such as a concrete pad underlying the greenhouse. As shown in FIG. 5, in one embodiment the base includes anchor holes 25 adapted to receive anchors. Anchors can be any of a variety of types include ground screws, or nut and bolt combinations securing the base to a deck structure. Where the greenhouse is secured to a concrete pad, the pad will generally have threaded posts aligned to extend upward through the anchor holes, then securable by means well known in the art.

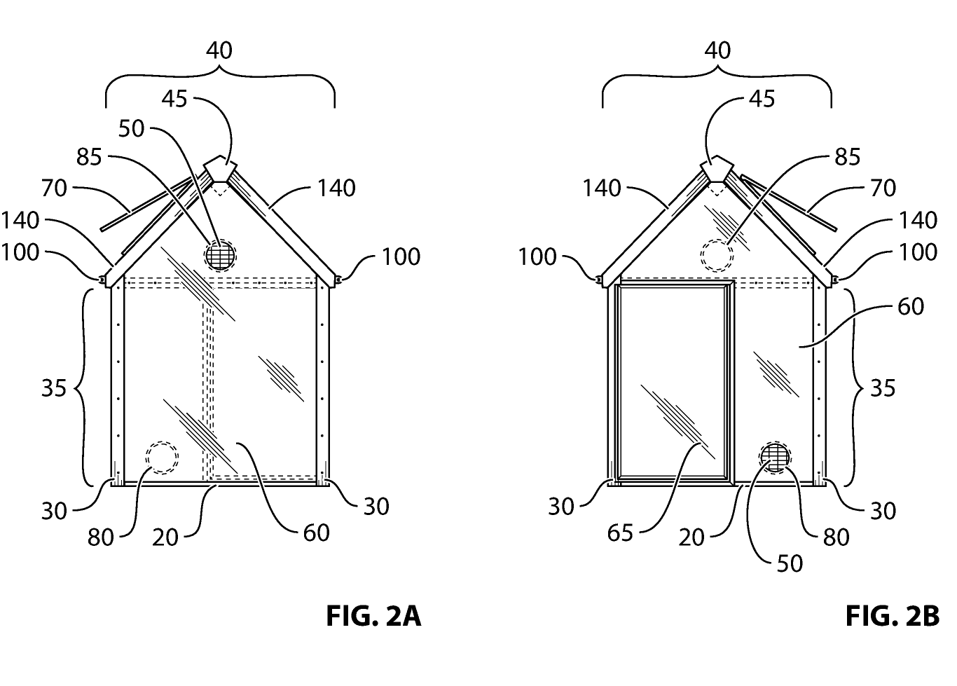

In its most basic design, the greenhouse will also comprise a frame 30, the frame comprises of a plurality of members that will define a structure having a length, a width and a height, thus forming a bounded region, or enclosure, in which plants can be placed for growing. As part of the overall structure of the greenhouse, there will also be a roof 40. The roof can be a classic style peaked roof, as shown in FIG. 1, FIGS. 2A and 2B, FIGS. 3A and 3B, and FIGS. 6A and 6B, or in some cases it might be desirable to have a flat roof. The precise style of the roof is not limiting to the scope of the invention. The roof can further include a cap structure 45, the cap providing a finishing cover between roof panel sections, such as is well known in the art of roof construction.

As shown in FIGS. 2A and 2B, FIGS. 3A and 3B, and FIG. 4A the frame and roof of the greenhouse will be further covered with a first covering material 50. The first covering material is configured to extend between over the spaces formed by the various frame elements. The first covering material will be a material sufficient to restrict access into the interior space of the greenhouse, except for an authorized user. Depending on the desired use of the greenhouse, and any regulatory requirements that apply to its use because the nature of the plants being grown inside the greenhouse, a variety of material might be used as a first covering material. For example, in some embodiments, a 10-gauge wire mesh might be used as a first covering material. In other embodiments, it might be preferable to use a mesh comprised of an expanded metal material. The present designed is readily adaptable to whatever type of covering one wishes to use. The first covering can be fixed to the frame on either the exterior or interior surface of the frame members and still be effective to perform the function for which it is designed.

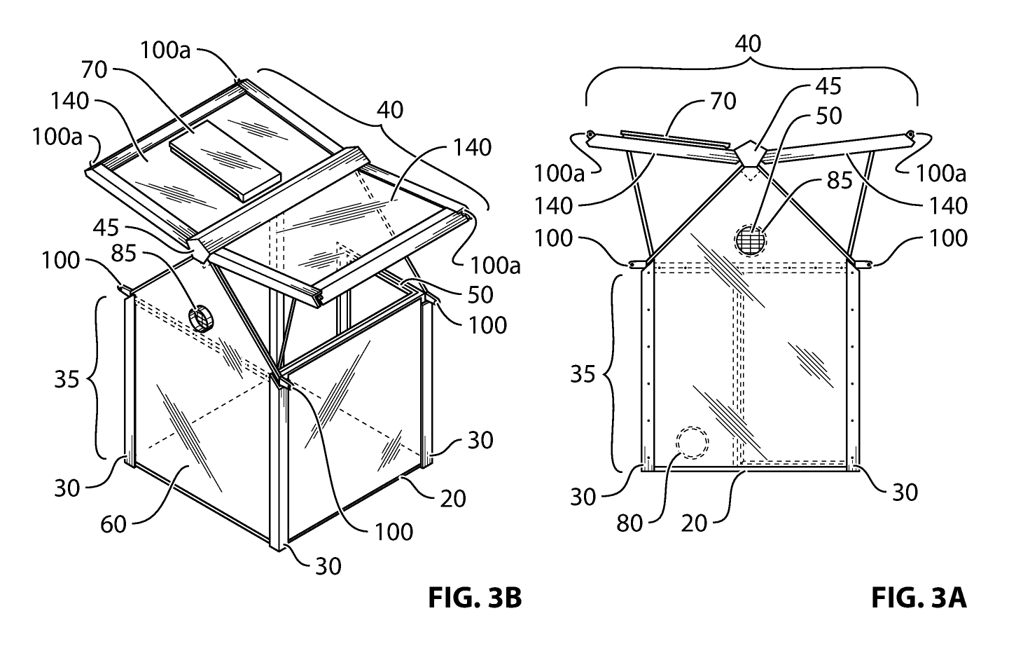

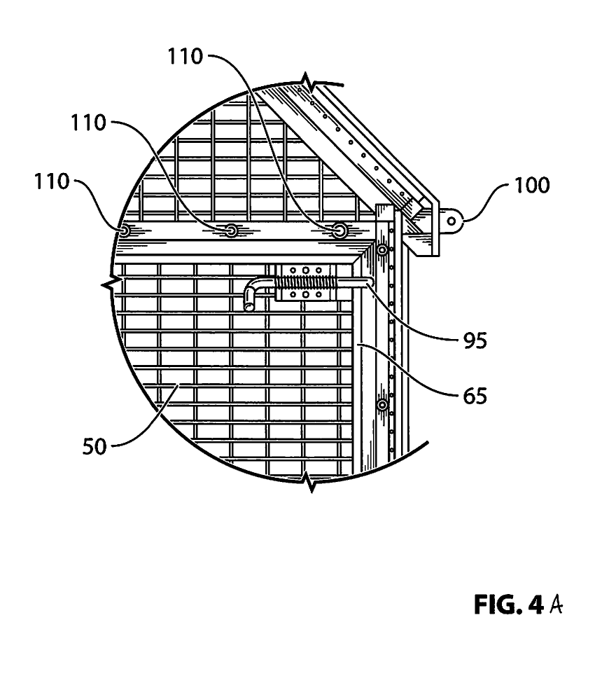

To better appreciate the relationship between the first and second covering, and referring to FIG. 3B, for example, the drawings have been crafted to show the second covering 60 overlying the first covering 50. For greater certainty, it is to be remembered that the second covering is substantially transparent. Thus, in the constructed greenhouse, one would be able to see the first covering underneath the second covering. The apparent look of the drawing where one might interpret that the second covering is opaque is simply for illustrative purpose so that it is clearly understood that there are first and second coverings and their relationship to each other. While in the depicted embodiments the first covering is shown more interior than the second covering, the position could be reversed such that the first covering (metal mesh for example) could overlay the substantially transparent second covering, and the greenhouse would function in the same way. Either arrangement is contemplated to fall within the scope of the invention as described herein.

In addition to the first covering, the outside of the greenhouse in most embodiments will be covered by a second covering material 60. The second covering material will generally be of a contiguous form, as opposed to the first covering, which generally will be more in the form of a mesh. The second covering material will be effective to limit the flow of air in and out of the greenhouse, and as such in most embodiment will cover all the spaces between the plurality of members that form the frame of the greenhouse. In prior art greenhouse, the second covering is functionally analogous to glass or transparent panes that will cover the frame structure, and which admit light while limiting air flow. Limiting air flow is important in the function of the greenhouse, as it allows the use to regulate the temperature inside the interior of the greenhouse, as well as relative humidity. This permits the use of the greenhouse when outside air temperatures are suboptimal, by retaining heat within the interior. Taken together, the first and second covering materials, in conjunction with the frame form a structure having base 20, sides 35 and a roof 40, as depicted in FIGS. 1, 2A, 2B, 3A, and 3B, for example.

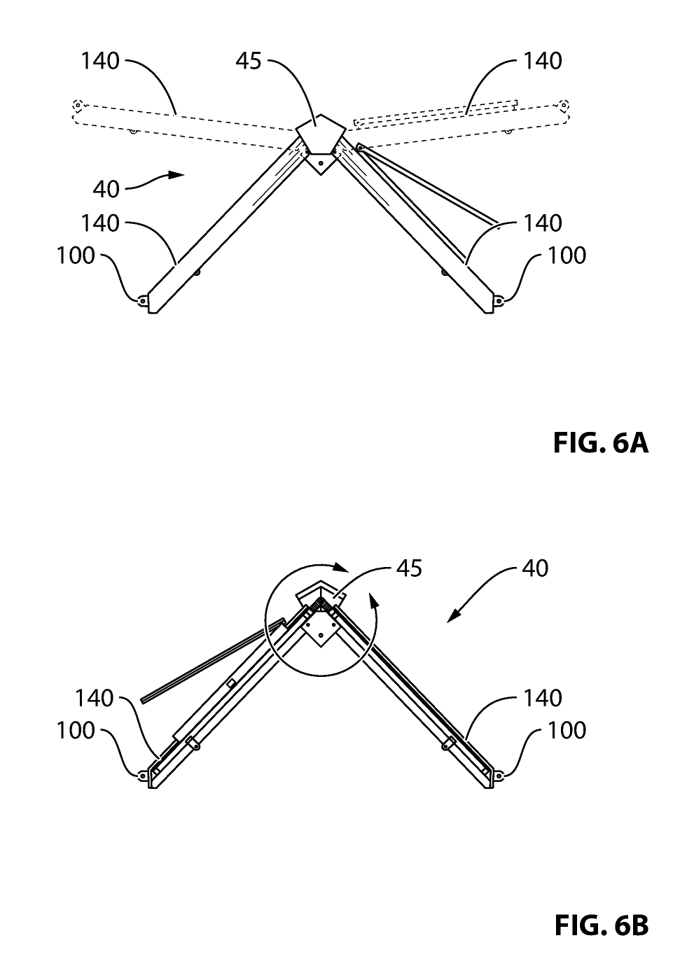

As shown in FIGS. 6A and 6B, in a preferred embodiment the roof can be configured such that the roof comprises moveable panels 140. In some embodiments, there will be at least one portion of the roof that comprises a moveable roof panel, while in some embodiments both portions of the roof can be designed to be moveable panels. In still other embodiments, the entire roof might be a single panel. As shown in FIG. 6A, the roof panels are designed to be moveable from an open (dashed lines) to a closed (solid lines) position. Hinges within the roof cap 45 would provide an attachment of the roof panel around which it would rotate between these two positions.

Most of the time, the moveable roof panels will be closed to prevent unauthorized access into the interior of the greenhouse. When desired one or more roof panels could be moved to an open position to allow access to the interior contents of the greenhouse, for example when adding or removing plants to the greenhouse, or for routine visual inspection of the contents of the greenhouse.

As is the case with most greenhouses, the present greenhouse includes means for providing ventilation. The purpose of the ventilation system is to provide for controlled air exchange between the interior of the greenhouse and the surrounding environment. Controlled ventilation permits the regulation of temperature and humidity within the greenhouse.

In some embodiments, as shown in FIGS. 1 through 5 inclusive, an example of a ventilation system will include one or more air intake vents 80, generally placed in the lower portion of a side of the greenhouse. In addition, there may also be one or more upper exhaust vents 85, generally located in the upper portion of a side of the greenhouse. As the interior of the greenhouse heats, the air inside will rise as air density decreases with increasing temperature. By controlled opening of the air intake 80 and air exhaust 85 vents. The flow of outside air into, through and out of the greenhouse may be controlled. In addition, within the roof may also be placed one or more roof vents 70, generally positioned in a moveable roof panel which may have a greater opening area that an exhaust vent, thereby increasing the volume of air that can flow through the greenhouse over time. The intake and exhaust vents can designed be moveable from a completely closed to completely open position, as well as partially opened positions, depending on the degree of air flow desired. The roof vents would be designed to have the same capability. In some cases, these various vents can be either manually opened by a user, or automatically controlled. In some embodiments, it might also be desirable to provide one or more fans to actively move air into, through and out of the greenhouse, rather than relying on the physics of passive air flow.

Consistent with the intention that the greenhouse will prevent unauthorized access to the interior contents, and as shown in FIGS. 2A and 2B, 3A and 3B, 4A, 4B, and 6A and 6B, the moveable roof panels can be configured to include one or more locking structures 100, 100a, adapted to be secured with a lock to prevent the roof panels form being opened without permission. In some embodiments, as shown in the figures referred to above, one part of the lock structure 100 could be located on each corner of a roof panel, where the roof panel engages a frame member at the junction between two top corners of adjacent sides of the greenhouse frame structure, with a complimentary structure 100a located on the frame of the greenhouse. In conjunction with a lock, the locking structures 100, 100a would provide a means to secure the moveable roof panel 140 to the frame such that unauthorized access to the interior of the greenhouse is substantially preventable. In other embodiments, it might be desirable to have a single lock mechanism located at a midpoint along the edge of a roof panel that engages a frame member forming a top of a side of the greenhouse. Either configuration will effectively prevent unauthorized opening of a moveable roof panel.

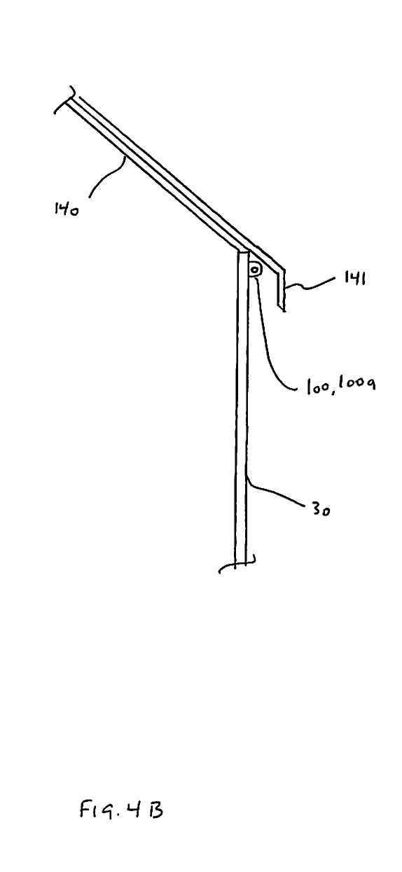

In some embodiments, as depicted in FIG. 4B, the greenhouse may include a trim piece 141 that is configured to partially cover the locking structure 100, 100a that serves to limit access to a lock used to secure the greenhouse and prevent unauthorized access. Analogous to similar security measures included on some types of tool boxes known in the art, the trim would permit access for a user to lock and unlocking whatever types of lock was to be used to secure the roof panel as described herein, but which would substantially prevent others from being able to circumvent the lock through means such as cutting the lock to gain unauthorized access. So, for example, the trim piece would make it virtually impossible to gain access to the lock with tools such as hacksaws or bolt cutters that might otherwise be used to disable or destroy the lock.

The greenhouse will be adapted to make use of any of several different types of locks, including key operated locks, padlocks, automatic locks, electronically controlled locks, time locks, and the like. The type of lock use in conjunction with the greenhouse is not limiting to the scope of the invention. In some cases, the moveable roof panel could include trim (not shown) that partially covers the lock, making it more difficult for an unauthorized user to gain access to the interior of the greenhouse by circumventing the lock (e.g., cutting the bolt).

The greenhouse can also include at least one securable access other than the roof panels already described. For example, and as shown in FIGS. 1, 2B and 3B, a side of the greenhouse can include an access door 65. The access door can provide an alternate means of entering the interior of the greenhouse, for example when setting up various racks of shelves or other structure on which planters which eventually be placed. As shown in FIG. 4A, an access door can have an additional means of locking to prevent unauthorized access. For example, in the preferred embodiment shown in FIG. 4A, an access door lock 95 can comprise a spring-loaded barrel bolt that is placed within the interior of the greenhouse so that it is only operable from the inside. Thus, to open the access door, one would first access the interior of the greenhouse via a moveable roof panel, and then operate the access door lock to release the access door and allow entry through that access route. FIG. 4A also gives a closer view of the mesh like structure of the first covering layer of the greenhouse, in this case as it might look if the second and third coverings are not yet installed on the greenhouse.

The greenhouse can also include a third covering material, the third covering material is generally fashioned from an opaque material such that when in place it will substantially prevent light from entering the interior of the greenhouse, as well as to prevent those outside the greenhouse from viewing the contents of the structure. The third covering material would be placed within the interior of the greenhouse. Thinking schematically, going from outside to inside the greenhouse would be: (1) exterior environment; (2) second covering material; (3) frame; (4) first covering material; (5) third covering material; and (6) interior of the greenhouse. In alternative embodiments, the order of these various components could be (1) exterior environment; (2) first covering material; (3) frame; (4) second covering material; (5) third covering material; and (6) interior of the greenhouse. In yet another embodiment the order could be (1) exterior environment; (2) first covering material; (3) second covering material; (4) frame; (5) third covering material; and (6) interior of the greenhouse. Thus, all such arrangements of the various layers are contemplated, with the exception that the third covering material will always be placed within the interior of the greenhouse so that it can be easily deployed or retracted, and so that only an authorized user can change the deployment configuration of that third covering material.

The third covering material can be designed to be deployable such that it can be extended to block light when that is desired, or retracted and stored for times when one wishes to provide illumination to the interior of the greenhouse. The greenhouse will also include structures for carrying and deploying the third covering material. As depicted in FIG. 4A, these can comprise rods 110, analogous to curtain rods, over which the third covering material can pass and be supported. The material itself could be deployable from a mechanism analogous to a window blind or curtain well known in the art of coverings, such that it can be deployed and retracted by pulling on the material to either withdraw it from a housing, or allowing it to be retracted back into said housing. In some embodiments, rods 110 can be placed near the top of the greenhouse, as shown in FIG. 4A, with another set installed at locations on the base, as shown in FIG. 5. Thus, a covering could be extended between these sets of rods in order to shield the contents of the greenhouse from view, or to restrict the amount of light entering the greenhouse.

In some cases, it may be sufficient to provide sufficient lighting for plant growth from ambient lighting. In these cases, the amount of light entering the greenhouse could be regulated by the degree to which the third covering material shades the interior of the greenhouse. In other cases, it may be desirable to equip the greenhouse with an artificial lighting system. A variety of lighting systems are suitable for use to encourage the growth of plants, and the choice of such a lighting system is not limiting to the scope of the invention. Similarly, placement of an artificial lighting system will depend on the type of plant being grown and the preference of the user of the greenhouse. Generally, one would usually place the lighting system above the plants, for example by mounting it on the upper frame members forming the side of the greenhouse, or hung from one or more of the moveable roof panels.

In some embodiments, the greenhouse can also comprise a control system, the control system configured to receive data from various sensors that measure light intensity and duration, temperature, relative humidity, soil water content, and the like, to determine a set of parameters optimal for the growth of the plants within the interior of the greenhouse. The control system would then be configured to achieve this optimal parameter set by regulating the operation of the ventilation system, an artificial lighting system (if so provided), and/or the deployment of the third covering material, and the operation of an automatic watering and nutrient providing system (if so provided).

In some cases, the control system could be automated and make use of a microprocessor system to both calculate the optimal parameter set, and then operate the various controllable features of the greenhouse to most closely achieve optimal conditions for growth within the greenhouse interior. In other cases, the control system could provide a readout to a user-readable display informing a user how to manually change controllable features of the greenhouse systems to achieve an optimal growth condition. The control system could also be configured to issue alerts or alarms to a user when condition deviate significantly from optimal conditions (e.g., temperature too hot or too cold), or when certain actions need to be taken as part of the life cycle of the plants being grown (e.g., reducing illumination to induce flowering).

It should also be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A securable greenhouse providing a secure facility and controlled environment for growing plants, comprising:
a base, the base comprising a structure having a length and a width configured to provide a means of securing the greenhouse to a location;
a frame, the frame connected to the base and comprising a plurality of frame members that define a structure having a length, a width and a height, thus forming a bounded interior region adapted to receiving plants, the bounded structure comprising sides and a roof;
a first covering material, the first covering material configured to extend over the spaces formed by the plurality of frame members, wherein the first covering material is effective to substantially limit unauthorized access into the greenhouse;
a second covering material, the second covering material overlying the first covering material, and effective to substantially limit the flow of air in and out of the interior of the greenhouse;
wherein the first and second covering materials cooperatively form a plurality of sides, and a roof for the greenhouse, and wherein the roof further comprises at least one moveable roof panel, the at least one moveable roof panel configured to be movable between a closed position and an open position;
a ventilation system, the ventilation system configured to provide controlled air exchange between the outside of the greenhouse and the interior of the greenhouse; and
at least one securable access, the at least one securable access configured to prevent unauthorized access to the interior of the greenhouse.

2. The greenhouse of claim 1, further comprising a third covering material, the third covering material configured to be deployable to regulate the amount of light that enters the greenhouse from outside, and to protect the contents of the greenhouse from being viewed from outside the greenhouse.

3. The greenhouse of claim 1, wherein the securable access comprises at least one of a side access door and the moveable roof panel.

4. The greenhouse of claim 3, wherein the moveable roof panel is configured to be moved between an open configuration and a closed configuration.

5. The greenhouse of claim 4, wherein the moveable roof panel further comprises a lock, to prevent unauthorized access to the interior of the greenhouse when the moveable roof panel is in the closed configuration.

6. The greenhouse of claim 1, wherein the ventilation system comprises at least one air intake vent and at least one air exhaust vent, and wherein each of the at least one air intake vent and the at least one air exhaust are moveable between a closed and an open configuration.

7. The greenhouse of claim 1, further comprising an artificial lighting system located within the interior of the greenhouse, the artificial lighting configured to provide a light source for plants placed within the greenhouse.

8. The greenhouse of claim 1, further comprising a control system, the control system configured to determine an optimal parameter set, a parameter set comprising an amount of illumination, water, nutrients and temperature to which plants within the greenhouse will be exposed within a pre-determined period of time, and wherein the control system is configured to adjust the operation of the ventilation system, artificial lighting system, water and nutrient system, and deployment of the third covering in order to substantially achieve the optimal parameter set.

9. The greenhouse of claim 8, wherein the control system is configured to be controlled a microprocessor.

10. The greenhouse of claim 8, wherein the control system is configured to provide data to a user in order to manually control the amount of illumination, water, nutrients and temperature to which plants within the greenhouse will be exposed within a pre-determined period of time, in order to substantially achieve the optimal parameter set.

11. The greenhouse of claim 1, wherein the base further comprises a plurality of anchors configured to secure the greenhouse to one of the ground, a deck structure or a substantially solid pad structure.

12. The greenhouse of claim 1, wherein the first covering comprises a metal mesh, and the second covering comprises a substantially transparent material.

13. The greenhouse of claim 2, wherein the third covering material is substantially opaque.

14. The greenhouse of claim 3, wherein the access door further comprises a locking mechanism accessible only from within the interior of the greenhouse.
